(19) United States
(12) Patent Application Publication
(10) Pub. No.: US 2024/0328347 A1
(43) Pub. Date: Oct. 3, 2024

(54) DUAL-CONNECTION CRANK-PISTON MECHANISM

(71) Applicant: Sichuan Beixin Hongneng Technology Research Institute, Chengdu (CN)

(72) Inventor: Xin SUN, Ningbo (CN)

(21) Appl. No.: 18/739,697

(22) Filed: Jun. 11, 2024

Related U.S. Application Data
(63) Continuation of application No. PCT/CN2022/097380, filed on Jun. 7, 2022.

(30) Foreign Application Priority Data
Dec. 28, 2021 (CN) 202111624964.X
Mar. 27, 2022 (CN) 202210307628.0

(51) Int. Cl. F02B 75/32

(52) U.S. Cl. CPC F02B 75/32

(57) ABSTRACT

The present disclosure relates to the technical field of power plants, and in particular to a dual-connection crank-piston mechanism, which includes a cylinder body, a piston, a crankshaft, and a frame. The piston and the crankshaft are hingedly connected to two connecting rods. Hinged ends of an inner connecting rod and an outer connecting rod are both hingedly connected to a slider or a swing arm. The slider is slidably connected to a guide rail. The swing arm is hingedly connected to the frame. Another end of the outer connecting rod is hingedly connected to a crankshaft shank. A stroke of the piston is greater than twice the length of the crankshaft handle. A upward running speed and a downward running speed of the piston have a 1.4- to 3-fold difference.

### CROSS REFERENCE

The present application is a continuation-application of International (PCT) Patent Application No. PCT/CN2022/097380 filed on Jun. 7, 2022, the entire content of which is hereby incorporated by reference in its entirety.

### TECHNICAL FIELD

The present disclosure relates to the technical field of power machines, and in particular, to a dual-connection crank-piston mechanism.

### BACKGROUND

A piston-crank structure, widely used in engines and other machinery, is a four-stroke engine. The four-stroke engine, without considering an exhaust advance angle, typically completes a working cycle after a crankshaft rotates 720 degrees. A rotation angle of the crankshaft from a top dead center to a bottom dead center of an inlet piston is 180 degrees, a rotation angle of the crankshaft from the bottom dead center of the piston to the top dead center in the compression stroke is 180 degrees; the rotation angle of the crankshaft from the top dead center to the bottom dead center of the piston is 180 degrees in a working stroke; and the rotation angle of the crankshaft from the bottom dead center to the top dead center of the piston is 180 degrees in an exhaust stroke. The rotation angle of the crankshaft is 180 degrees for each stroke. A four-cylinder engine may work continuously without considering an exhaust advance angle, the power output of a three-cylinder engine is incoherent. Each cylinder of the three-cylinder engine works, the rotation angle of the crankshaft is only 180°, so there is a pause zone of 60°, which makes it difficult to avoid vibrations of the engine. Due to the disadvantages of the three-cylinder engine such as vibration, noise, insufficient power, the internal parts of the engine being very vulnerable to damage, there is the problem of the power interruption of the crankshaft of the four-cylinder engine due to the widely used exhaust advance angle. Therefore, designing a working angle of an engine needs to be researched.

### SUMMARY

A dual-connection crank-piston mechanism includes a cylinder body, a piston, a crankshaft and a frame. Two connecting rods connected in series are hinged between the piston and the crankshaft, hinged ends of both an inner connecting rod and an outer connecting rod are hinged to a slider or a swing arm, the slider is slidably connected to a guide rail, the swing arm is hinged to the frame, and another end of the outer connecting rod is hinged to a crankshaft shank. The stroke of the piston is greater than twice the length of the crankshaft shank, and a difference between an upward movement speed and a downward movement speed of the piston is 1.4 to 3 times.

### BRIEF DESCRIPTION OF DRAWINGS

FIG. 1 is a schematic structural view of a crankshaft on a left side of a curved guide rail and an inner connecting rod on a higher end point according to the present disclosure.

FIG. 2 is a schematic structural view of a crankshaft on a left side of a curved guide rail and an inner connecting rod on a lower end point according to the present disclosure.

FIG. 3 is a schematic structural view of a track combination of a crankshaft on a left side of a curved guide rail according to the present disclosure.

FIG. 4 is a schematic structural view of a cam on a curved guide rail according to the present disclosure.

FIG. 5 is a schematic structural view of a crankshaft on a right side of a curved guide rail and an inner connecting rod on a higher end point according to the present disclosure.

FIG. 6 is a schematic structural view of a crankshaft on a right side of a curved guide rail and an inner connecting rod on a lower end point according to the present disclosure.

FIG. 7 is a schematic structural view of a track combination of a crankshaft on a right side of a curved guide rail according to the present disclosure.

FIG. 8 is a schematic structural view of a lead screw of a straight and curved guide rail according to the present disclosure.

FIG. 9 is a schematic structural view of a crankshaft on a left side of a straight and curved guide rail and an inner connecting rod on a higher end point according to the present disclosure.

FIG. 10 is a schematic structural view of a crankshaft on a left side of a straight and curved guide rail and an inner connecting rod on a lower end point according to the present disclosure.

FIG. 11 is a schematic structural view of a track combination of a crankshaft on a left side of a straight and curved guide rail according to the present disclosure.

FIG. 12 is a schematic view of a swing arm on a left side of a crankshaft and an inner connecting rod on a higher end point according to the present disclosure.

FIG. 13 is a schematic view of a swing arm on a left side of a crankshaft and an inner connecting rod on a lower end point according to the present disclosure.

FIG. 14 is a schematic view of a track combination of a swing arm according to the present disclosure.

FIG. 15 is a schematic structural view of a crankshaft on left side of a special-shaped swing arm and an inner connecting rod on a lower end point according to the present disclosure.

FIG. 16 is a schematic structural view of a crankshaft on a left side of a special-shaped swing arm and an inner connecting rod on a higher end point according to the present disclosure.

FIG. 17 is a schematic view of a track combination of a crankshaft on a left side of a special-shaped swing arm according to the present disclosure.

FIG. 18 is a schematic structural view of a track combination of a special-shaped swing arm and curved gear rack according to the present disclosure.

FIG. 19 is a schematic structural view of a crankshaft on a right side of a special-shaped swing arm and an inner connecting rod on a lower end point according to the present disclosure

FIG. 20 is a schematic structural view of a crankshaft on a right side of a special-shaped swing arm and an inner connecting rod on a higher end point according to the present disclosure.

FIG. 21 is a schematic view of a track combination of a crankshaft on a right side of a special-shaped swing arm according to the present disclosure

Description of reference signs: 01—cylinder body; 02—spark plug and fuel injection assembly; 03—inlet valve; 04—outlet valve; 10—piston; 20—inner connecting rod; 30—outer connecting rod; 40—crankshaft shank; 41—crankshaft; 50—curved guide rail; 60—straight and curved guide rail; 61—cam; 62—fork; 63—lead screw; 64—nut; 70—swing arm; 71—curved gear rack; 72—gear; 73—locking gear; 81—higher end point; 82—lower end point.

### DETAILED DESCRIPTION OF THE EMBODIMENTS

### Detailed Way

In order to make the objects, features and advantages of the present disclosure more obvious and easy to understand, the technical solutions in the embodiments of the present disclosure will be clearly and completely described below in conjunction with the drawings in the embodiments of the present disclosure. Obviously, the described embodiments are only part of the embodiments of the present disclosure, but not all of the embodiments. Based on the embodiments of the present disclosure, all other embodiments obtained by those skilled in the art without making any creative efforts shall fall within the protection scope of the present disclosure.

The principle and spirit of the present disclosure will be described below with reference to several exemplary embodiments. It should be understood that these embodiments are provided only to enable those skilled in the art to better understand and further implement the present disclosure, but are not intended to limit the scope of the present disclosure in any way. On the contrary, these embodiments are provided to make the present disclosure more thorough and complete, and to fully convey the scope of the present disclosure to those skilled in the art.

The technical solution of the present disclosure will be further explained below in combination with the accompanying drawings and specific embodiments.

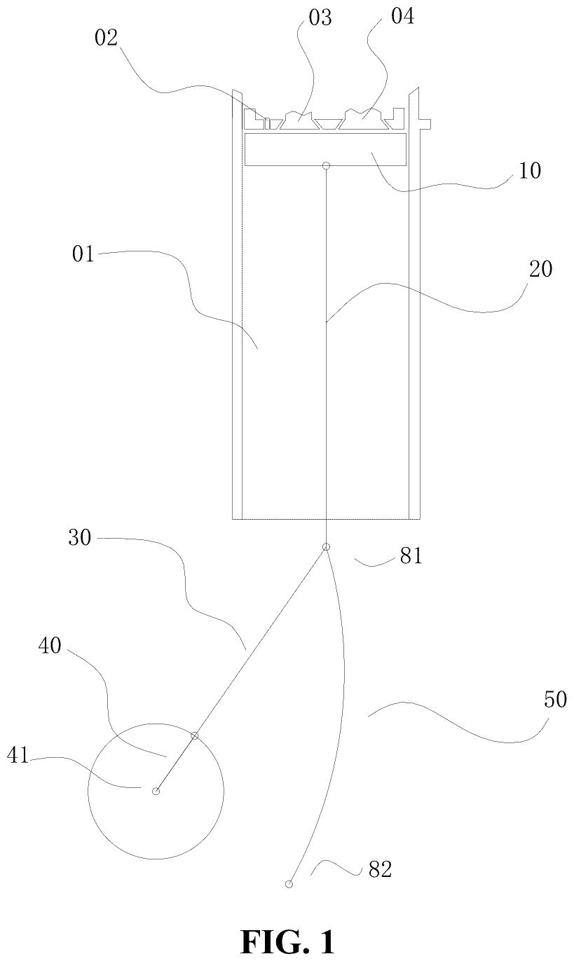

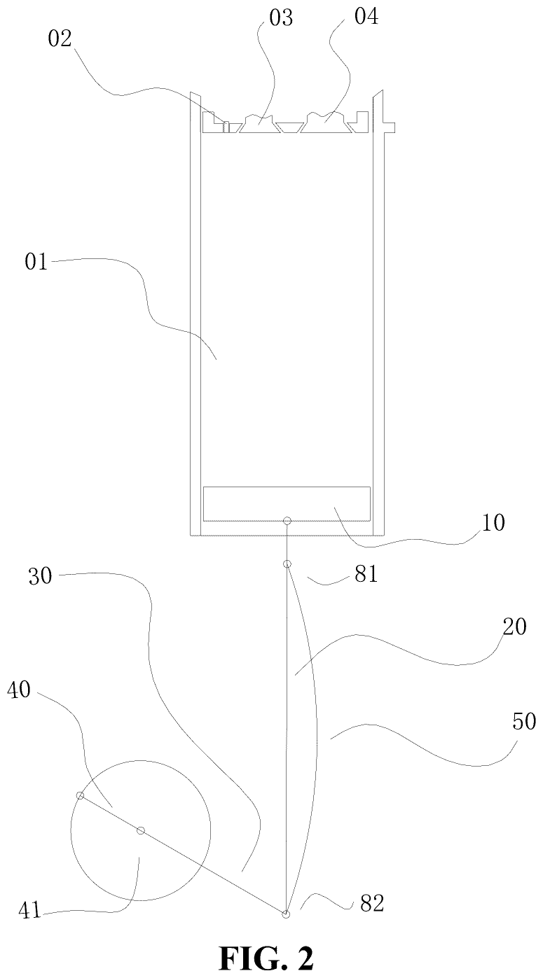

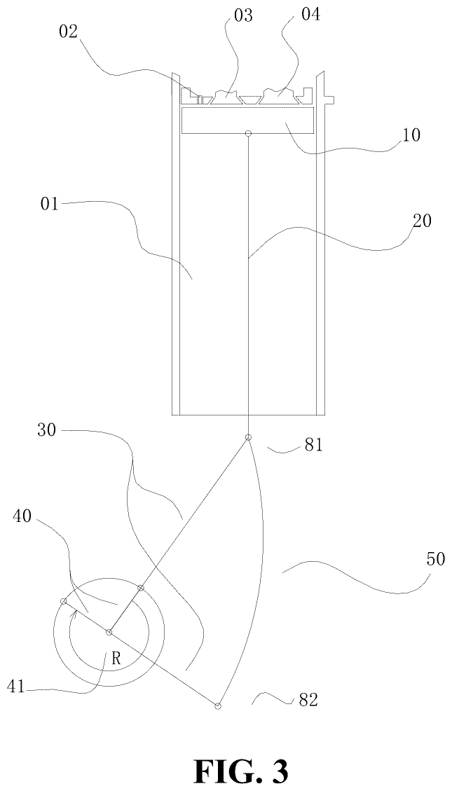

Embodiment 1: as illustrated in FIG. 1, FIG. 2 and FIG. 3, a dual-connection crank-piston mechanism includes a cylinder body 01, a spark plug and fuel injection assembly 02, an inlet valve 03, an outlet valve 04 and a piston 10. The piston 10 is hinged to an inner connecting rod 20, an outer end of the inner connecting rod 20 is hinged to both a outer connecting rod 30 and a slider on a curved guide rail 50; a crankshaft 41 is arranged at a left side of an axis of the cylinder body 01, the slider always move at a right side of an axis of the cylinder body 01; the outer connecting rod 30 is hinged to a crankshaft shank 40, and the crankshaft shank 40 pushes the crankshaft 41. The structural parameters of this engine are: if the stroke of the piston 10 is set to 100, then the length of the inner connecting rod 20 is 110, the length of the outer connecting rod 30 is 67.8, the length of the crankshaft shank 40 is 20, and the radius of curvature of the curved guide rail 50 is 128.44.

Since the outer connecting rod 30 and the curved guide rail 50 are adopted in the present disclosure, the force position of the crankshaft shank 40 is changed, the rotation angle of the crankshaft shank 40 are changed when the piston 10 moves downward and upward. The rotation speed of the crankshaft 41 is even. The piston 10 moves downwards, pushing the crankshaft 40 to move downwards through the inner connecting rod 20 and the outer connecting rod 30, the crankshaft 41 rotates clockwise until the outer connecting rod 30 overlaps with the crankshaft shank 40, and the piston 10 reaches a bottom dead end. This is the movement process of the cylinder body and the piston 10. As the crankshaft 41 continues to rotate, the piston 10 is pushed upwards by the crankshaft shank 40, the outer connecting rod 30, and the inner connecting rod 20, and piston 10 goes straight up to a top dead end. This is the exhaust and compression activity of the cylinder body. The movement process of the piston 10 is even. The downward movement time of the piston 10 is far longer than the upward movement time of the piston 10, and the upward movement speed of the piston 10 is three times of the downward movement speed of the piston 10, and the rotation angle R of the crankshaft shank 40 is 270 degrees during the inlet and working of the piston 10. The piston 10 of the engine of the present disclosure bears few lateral forces, which are mainly borne by the slider and transmitted to the curved guide rail 50, thereby increasing the service life of the engine, reducing the torque-free running time of the crankshaft 41, providing a smoother power output, particularly reducing the jitters of a three-cylinder engine, and having a wide market prospect.

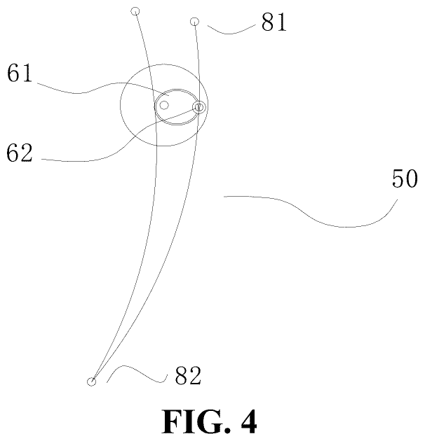

Embodiment 2: as illustrated in FIG. 1, FIG. 2, FIG. 3 and FIG. 4, a dual-connection crank-piston mechanism differs from Embodiment 1 in that: a curved guide rail 50 is hinged to a frame at a lower end point 82 of an inner connecting rod; a cam 61 driven by a motor is provided below a higher end point 81 of the inner connecting rod; a fork 62 hinged is provided in a groove of the cam 61; and the fork 62 is slidably connected to the curved guide rail 50.

The motor drives the cam 61 to rotate, the cam 61 drives the fork 62 to shift, and the shifting of the fork 62 causes the curved guide rail 50 to swing along the lower end point 82 of the inner connecting rod, thereby generating a change in the stroke of the piston 10, causing a change in the compression ratio, and being beneficial to various power outputs the engine. Other structures and principles are the same as those in Embodiment 1, and are not repeated herein.

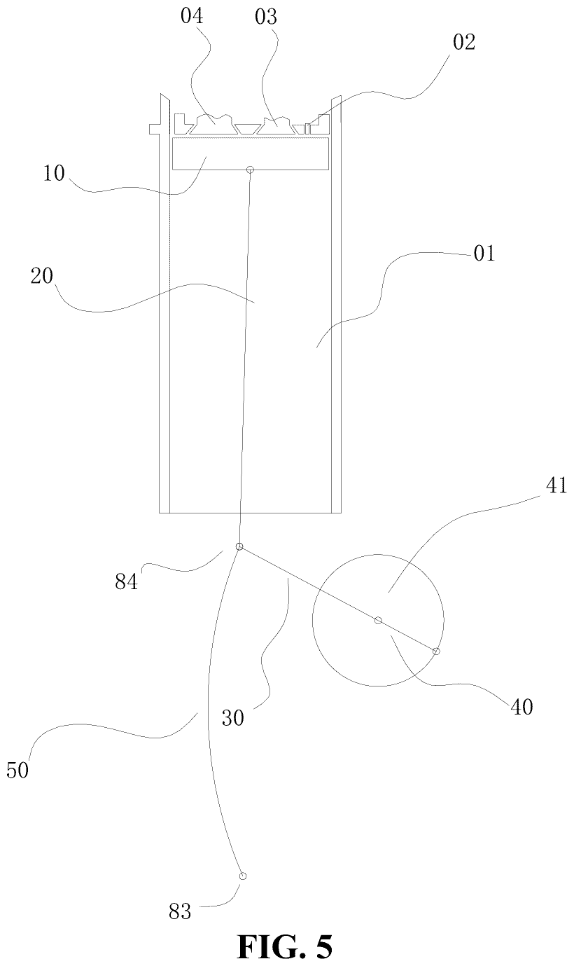

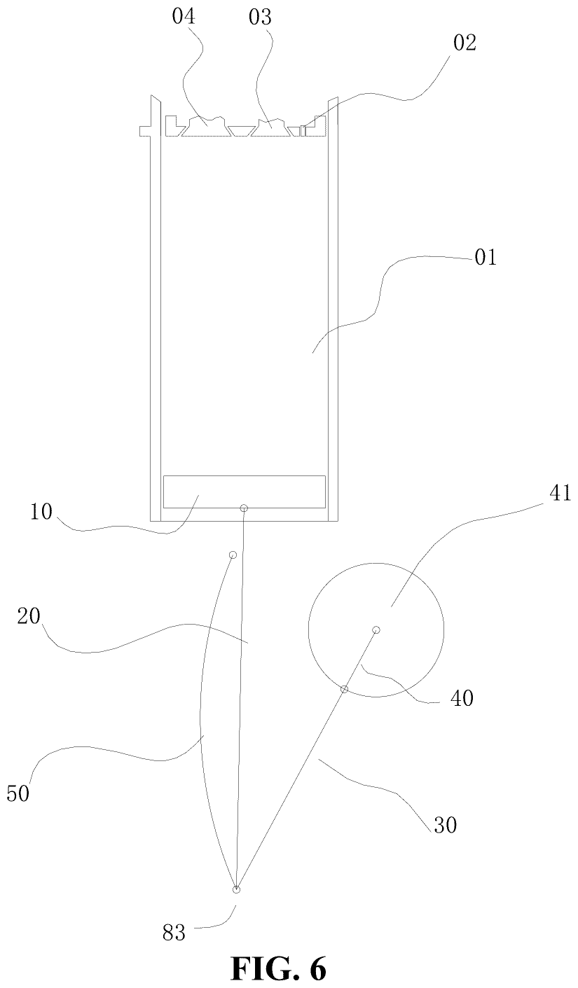

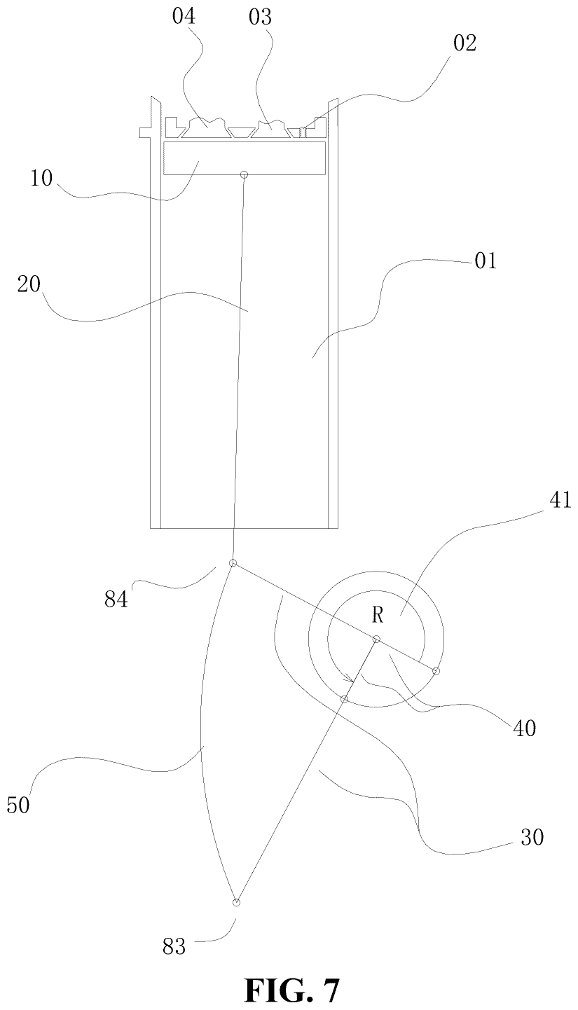

Embodiment 3: as illustrated in FIG. 5, FIG. 6 and FIG. 7, a dual-connection crank-piston mechanism differs from Embodiment 1 in that: a crankshaft 41 is provided at a right side of an axis of the cylinder body 01, and a slider always runs at a left side of the axis the cylinder body.

The piston 10 moves downward to pull the crankshaft shank 40 to move upward through the inner connecting rod 20 and the outer connecting rod 30, and the crankshaft 41 rotates counterclockwise until the outer connecting rod 30 and the crankshaft shank 40 are in a straight line, and the piston 10 moves to the bottom dead center. This is the working process of the cylinder body and the movement process of the piston 10, and the angle R is 270 degrees. Since the crankshaft 41 continues to rotate, the piston 10 is pushed upward through the crankshaft shank 40, the outer connecting rod 30 and the inner connecting rod 20, and the piston 10 moves upward to the top dead center. This is the exhaust process of the cylinder body and the compression process of the piston 10; the upward speed of the piston 10 is 3 times the downward speed, and the angle R is 270 degrees. Other structures and principles are the same as those in Embodiment 1, and are not repeated herein.

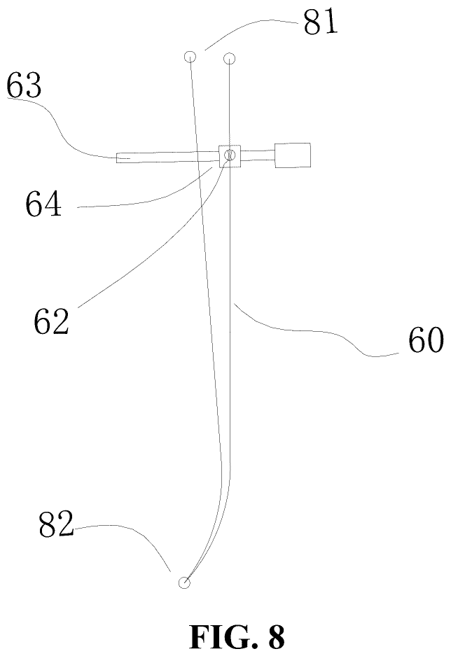

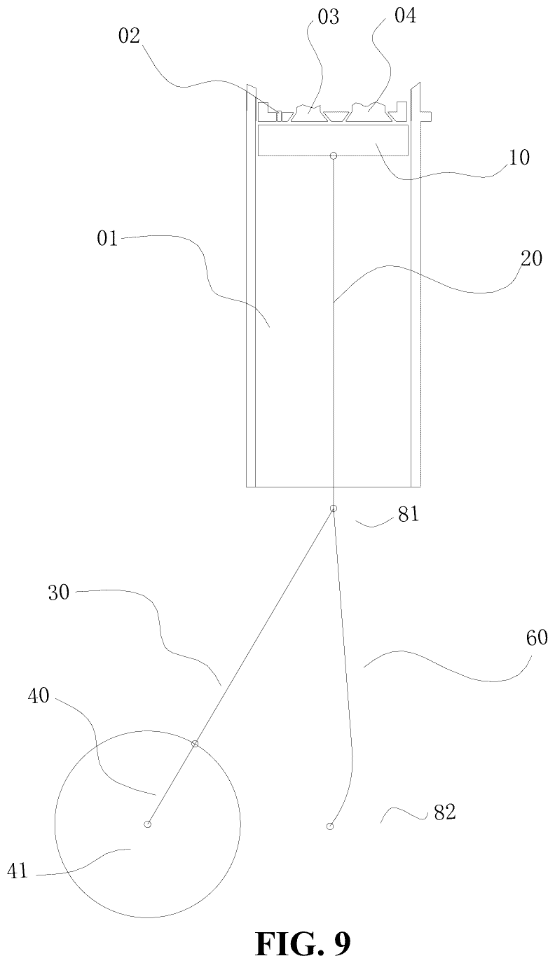

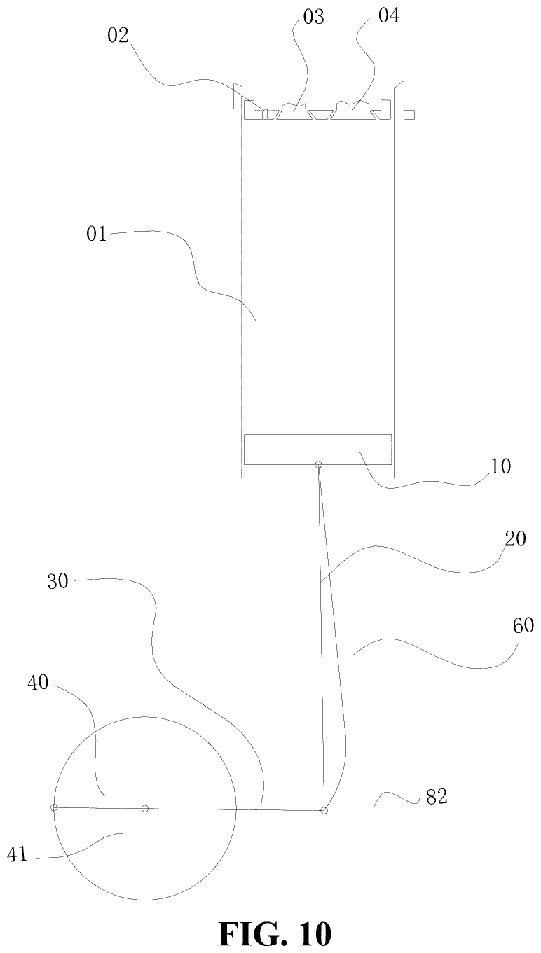

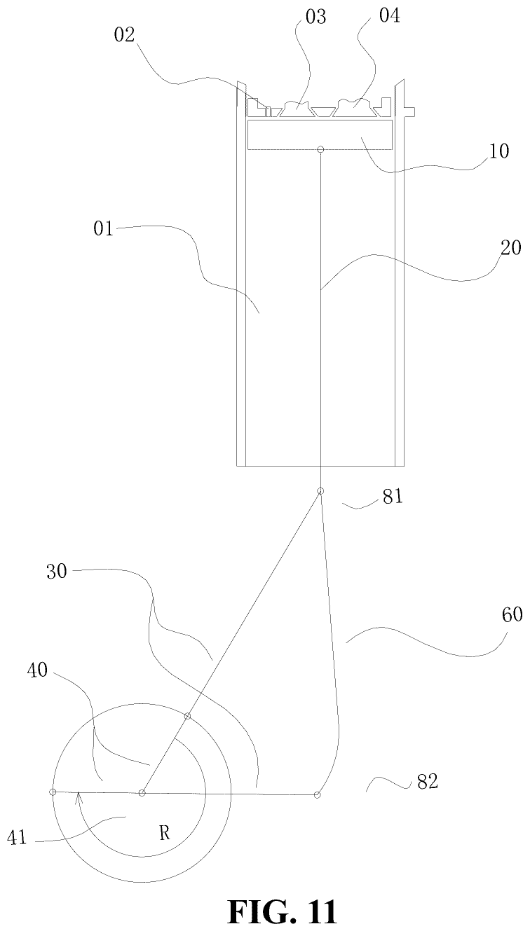

Embodiment 4, as illustrated in FIG. 8, FIG. 9, FIG. 10 and FIG. 11, a dual-connection crank-piston mechanism differs from Embodiment 1 in that: the engine adopts a straight and curved guide rail 60. The straight and curved guide rail 60 is hinged to a frame at a lower end point 82. The straight and curved guide rail 60 is provided with a lead screw 63 driven by a motor at a higher end point 81, the lead screw 63 pushes a nut 64, the nut 64 is hinged with a fork 62, and the fork 62 is slidably connected with the straight and curved guide rail 60. The structural parameters of this engine are changed as follows: when the stroke of the piston 10 is set to 100, the length of the inner connecting rod 20 is 110, the length of the outer connecting rod 30 is 86.6, the length of the crankshaft shank 40 is 28.87, and the upward movement speed of the piston 10 is twice the downward movement speed, the rotation angle R of the crankshaft shank 40 is 240 degrees when the piston 10 works in the downward movement direction. The engine pushes the lead screw 63 to rotate, the lead screw 63 shifts the fork 62 hinged to the nut 64. The shift of the fork 62 results in the swinging of the straight and curved guide rail 60 along the lower end point of the inner connecting rod, which leads to the change of the stroke of the piston 10 and the compression ratio and is beneficial to the output of various powers. Other structures and principles are the same as those in Embodiment 1, and are not repeated herein.

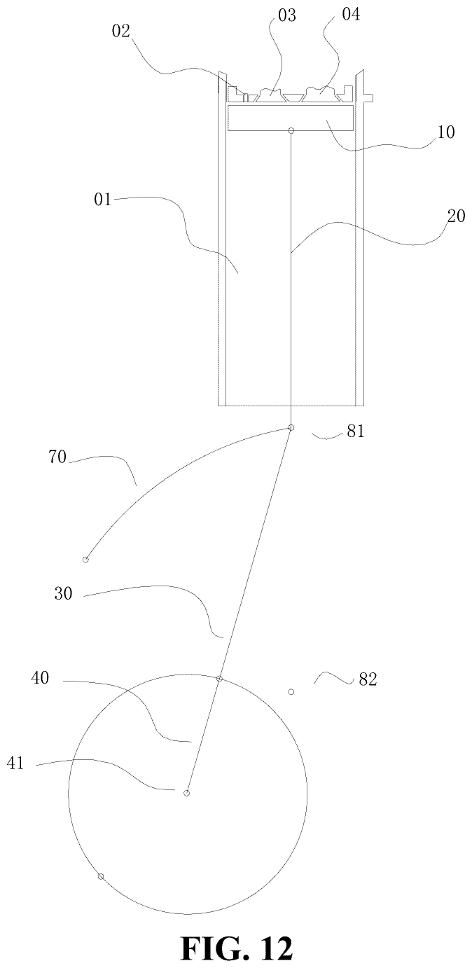

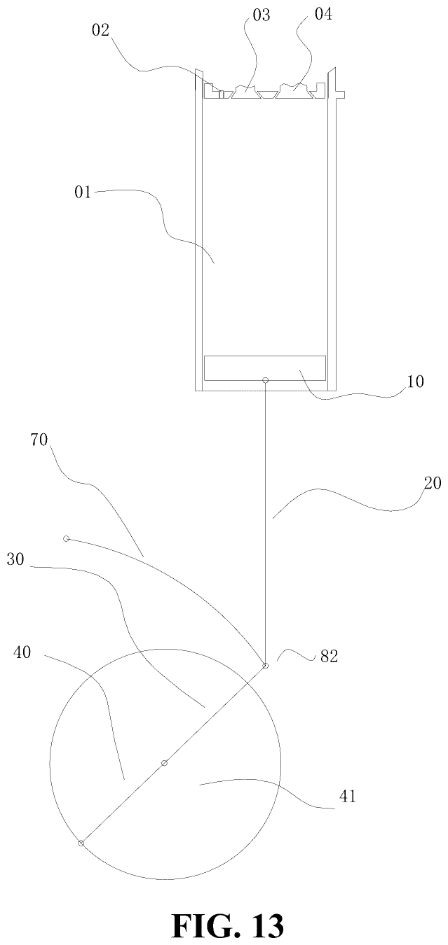

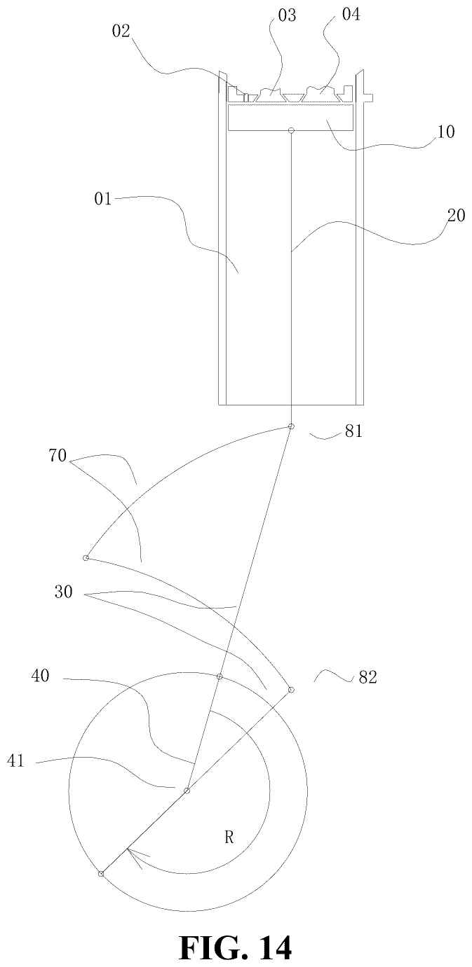

Embodiment 5, as illustrated in FIG. 12, FIG. 13 and FIG. 14, a dual-connection crank-piston mechanism differs from Embodiment 1 in that: the engine does not adopts a guide rail, but adopts a curved swing arm 70 on a side of the crankshaft; the structural parameters of this engine are as follows: the length of the outer connecting rod 30 is 98.82, the length of the crankshaft shank 40 is 45.06, the straight-line length of the swing arm 70 is 92.73, the radius of curvature is 117.9, the upward movement speed of the piston 10 is 1.4 times of the downward air inlet and working speed, and the rotation angle R of the crankshaft shank 40 is 210 degrees when the piston 10 works in the downward movement direction. Other structures and principles are the same as those in Embodiment 1, and are not repeated herein.

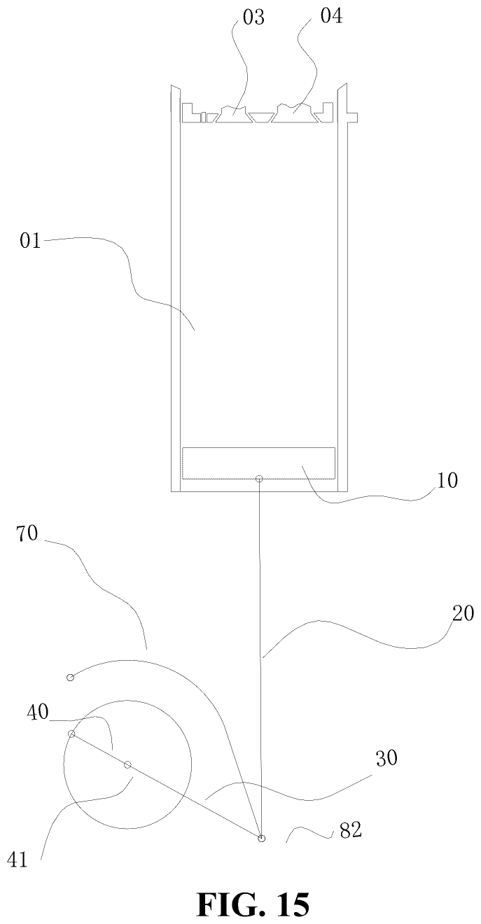

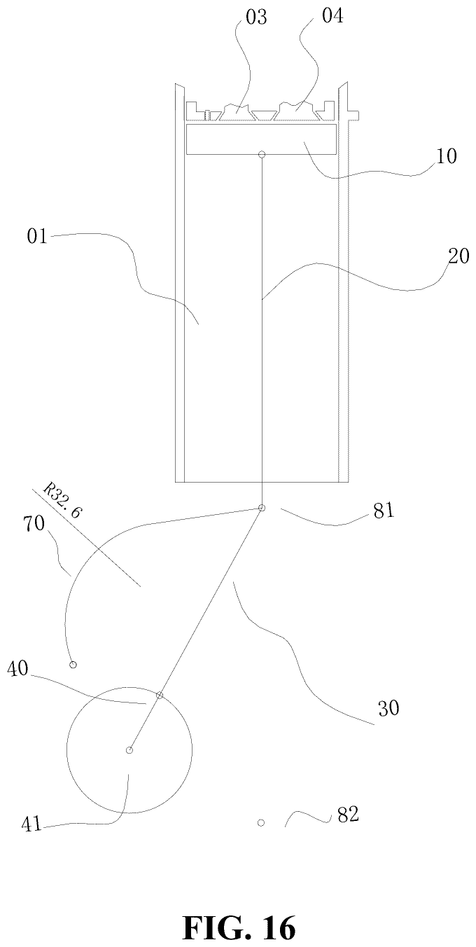

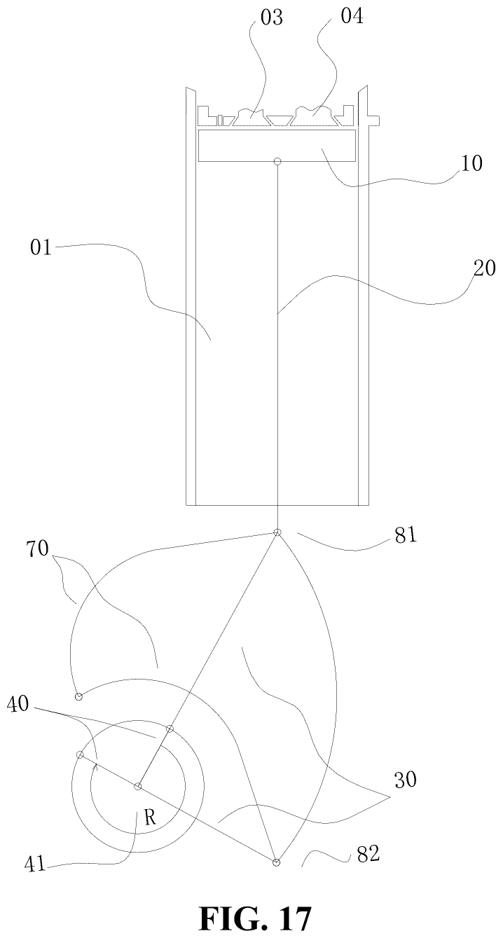

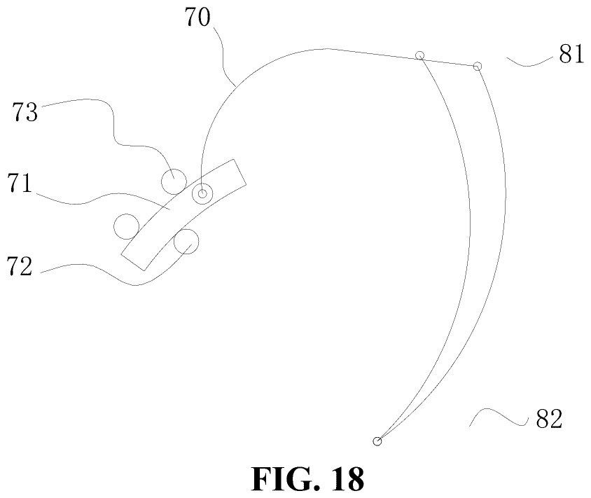

Embodiment 6: as illustrated in FIG. 15, FIG. 16, FIG. 17 and FIG. 18, a dual-connection crank-piston mechanism differs from Embodiment 5 in that: the length of an outer connecting rod 30 is 67.8, the length of a crankshaft shank 40 is 20, the straight-line length of a swing arm 70 is 37.8, the radius of a curvature is 32.6, the upward movement speed of a piston 10 is 3 times of the downward air inlet and working speed, and the rotation angle R of the crankshaft shank 40 is 270 degrees when the piston 10 works in the downward movement direction, the curved swing arm 70 is hinged to an curved gear rack 71, the curved gear rack 71 engages with a gear 72 driven by a motor, an outer arc surface of the curved gear rack 71 is connected to a locking gear 73, and the locking gear 73 is locked once the gear 72 stops moving. Through the movement of the curved gear rack 71, the positions of the inner connecting rod 20 and the outer connecting rod 30 which are jointly hinged to the swing arm 70 are changed, thereby generating a stroke change of the piston 10, changing the compression ratio of the engine, and being beneficial to various power outputs of the engine.

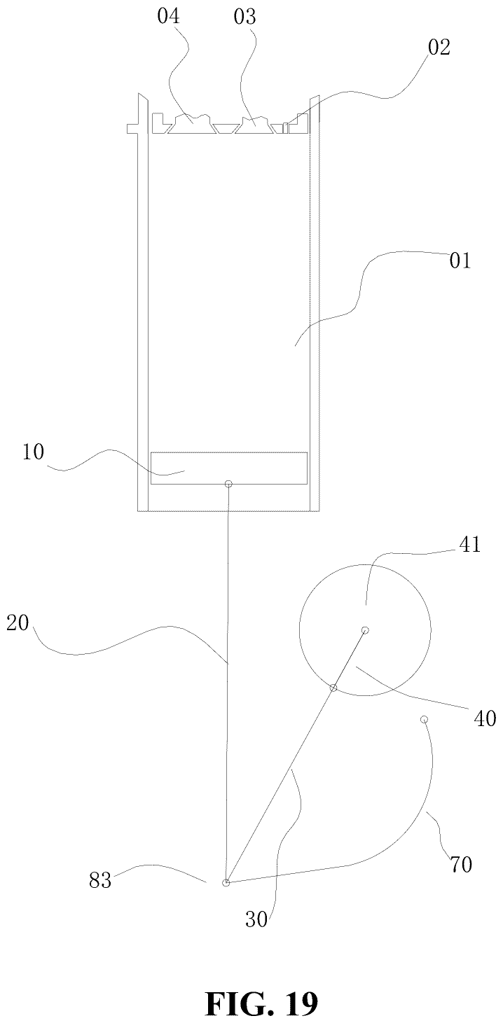

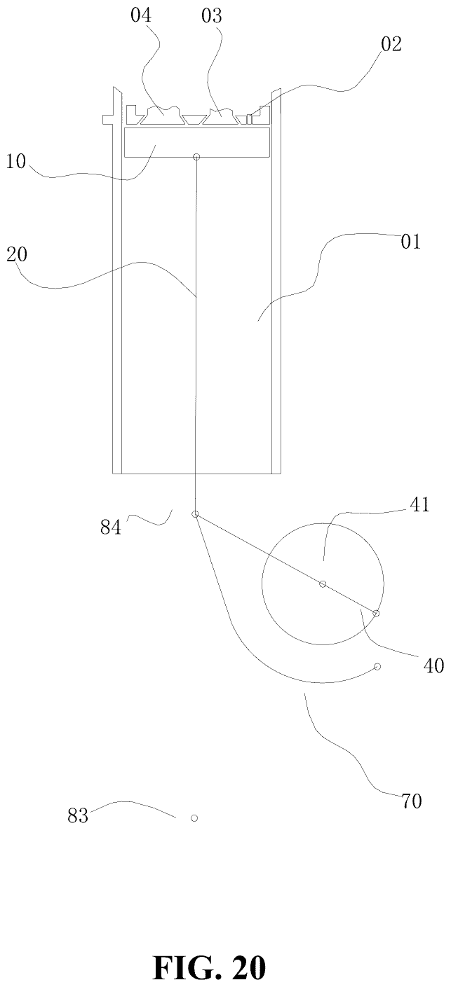

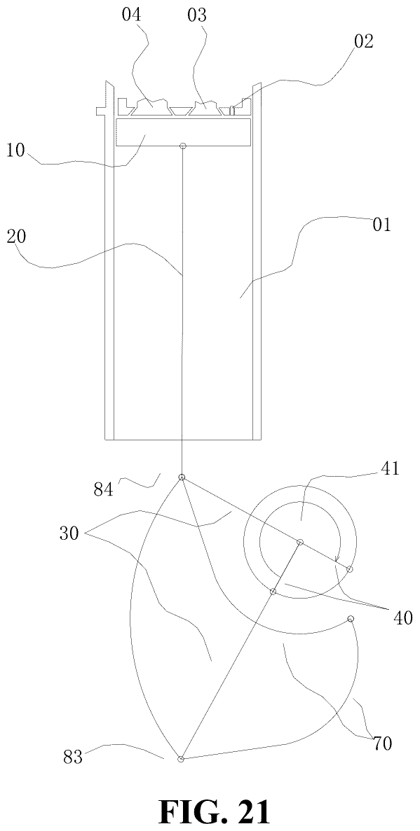

Embodiment 7: as illustrated in FIG. 19, FIG. 20 and FIG. 21, a dual-connection crank-piston mechanism includes a cylinder body 01, an inlet valve 03, an outlet valve 04 and a piston 10. A crankshaft 41 is on a right side of an axis of the cylinder body 01. A hinge point of an inner connecting rod 20 and an outer connecting rod 30 always runs at a left side of an axis of the cylinder body 01. The piston 10 is hinged to the inner connecting rod 20, one end of the inner connecting rod 20 is hinged to both the outer connecting rod 30 and a swing arm 70, the swing arm 70 is composed of an arc-shaped body and a straight rod, the outer connecting rod 30 is hinged to a crankshaft shank 40, and the crankshaft shank 40 pushes the crankshaft 41. The structural parameters are as follows: when the stroke of the piston 10 is set as 100, then the length of the inner connecting rod 20 is 110, the length of the outer connecting rod 30 is 67.8, the length of the crankshaft shank 40 is 20, and the radius of the swing arm 70 is 78.

The mechanism of the present disclosure is applied to an air pump. The crankshaft 41 rotates counterclockwise, the crankshaft 41 pushes the crankshaft shank 40, the crankshaft shank 40 pushes the outer connecting rod 30, the outer connecting rod 30 pushes the inner connecting rod 20 and the swing arm 70 to rotate upward, and the inner connecting rod 20 pushes the piston 10 to compress air in the cylinder body upwards to be discharged from the outlet valve 04 and stops at the top dead center. The crankshaft 41 rotates counterclockwise at 270 degrees, and at this moment, the outlet valve 04 is closed and the inlet valve 03 is opened, the crankshaft 41 rotates counterclockwise, the piston moves downward, until the crankshaft 41 rotates 90 degrees counterclockwise and the piston reaches the bottom dead center. In other words, the upward movement time of the piston 10 is three times that of the downward movement time, thereby reducing the running speed of the piston compressing the air, improving the stress condition of the crankshaft, and improving the power utilization efficiency.

The foregoing descriptions are merely specific embodiments of the present disclosure, but are not intended to limit the protection scope of the present disclosure. Any variation or replacement readily figured out by those skilled in the art within the technical scope disclosed in the present disclosure shall belong to the protection scope of the present disclosure. Therefore, the protection scope of the present disclosure shall be subject to the protection scope of the claims.

What is claimed is:

1. A dual-connection crank-piston mechanism, comprising a cylinder body, a piston, a crankshaft, and a frame, wherein two connecting rods connected in series are hinged between the piston and the crankshaft, hinged ends of both an inner connecting rod and an outer connecting rod are hinged to a slider or a swing arm, the slider is slidably connected to a guide rail, the swing arm is hinged to the frame, and another end of the outer connecting rod is hinged to a crankshaft shank; and a stroke of the piston is greater than twice a length of the crankshaft shank, and a difference between an upward movement speed and a downward movement speed of the piston is 1.4 to 3 times.

2. The dual-connection crank-piston mechanism according to claim 1,
wherein an outer end hinge point of the inner connecting rod always moves at one side of an axis of the piston.

3. The dual-connection crank-piston mechanism according to claim 1,
wherein the guide rail has a structure of a curved surface.

4. The dual-connection crank-piston mechanism according to claim 1,
wherein the guide rail has a structure of a straight line and an curved surface at a tail of the guide rail.

5. The dual-connection crank-piston mechanism according to claim 3,
wherein one end of the guide rail is hinged to the frame, a cam driven by a motor is provided at another end of the guide rail, a fork hinged is provided in a groove of the cam, and the fork is slidably connected to the guide rail.

6. The dual-connection crank-piston mechanism according to claim 4,
wherein one end of the guide rail is hinged to the frame, a cam driven by a motor is provided at another end of the guide rail, a fork hinged is provided in a groove of the cam, and the fork is slidably connected to the guide rail.

7. The dual-connection crank-piston mechanism according to claim 3,
wherein one end of the guide rail is hinged to the frame, a lead screw driven by a motor is provided at another end of the guide rail, and a nut on the lead screw is connected to the fork of the guide rail.

8. The dual-connection crank-piston mechanism according to claim 4,
wherein one end of the guide rail is hinged to the frame, a lead screw driven by a motor is provided at another end of the guide rail, and a nut on the lead screw is connected to the fork of the guide rail.

9. The dual-connection crank-piston mechanism according to claim 2,
wherein a hinge point of the swing arm and the crankshaft are located on a same side.

10. The dual-connection crank-piston mechanism according to claim 9,
wherein the hinge point of the swing arm is below the crankshaft.

11. The dual-connection crank-piston mechanism according to claim 10,
wherein a hinge point of the swing arm is provided on a curved gear rack, and a driving gear engaged with the curved gear rack drives the curved gear rack to swing around a lower end point of the inner connecting rod.

12. The dual-connection crank-piston mechanism according to claim 11,
wherein a radius of curvature of the curved gear rack is the same as a distance from the hinge point of the swing arm to the lower end point of the inner connecting rod.

13. The dual-connection crank-piston mechanism according to claim 1,
wherein a rotation angle of the crankshaft from a top dead center to a bottom dead center of the piston ranges from 210 degrees to 270 degrees.

14. A dual-connection crank-piston mechanism, comprising a cylinder body, a piston and a crankshaft, wherein two connecting rods connected in series are hinged between the piston and the crankshaft, hinged ends of both an inner connecting rod and an outer connecting rod are hinged to a slider or a swing arm, the slider is slidably connected to a guide rail, and another end of the outer connecting rod is hinged to a crankshaft shank; and a stroke of the piston is greater than twice a length of the crankshaft shank, and a difference between an upward movement speed and a downward movement speed of the piston is 1.4 to 3 times.

15. The dual-connection crank-piston mechanism according to claim 14,
wherein an outer end hinge point of the inner connecting rod always moves at one side of an axis of the piston.

16. The dual-connection crank-piston mechanism according to claim 14,
wherein the guide rail has a structure of a curved surface.

17. The dual-connection crank-piston mechanism according to claim 14,
wherein the guide rail has a structure of a straight line and an curved surface at a tail of the guide rail.

18. The dual-connection crank-piston mechanism according to claim 14,
wherein a rotation angle of the crankshaft from a top dead center to a bottom dead center of the piston ranges from 210 degrees to 270 degrees.

19. The dual-connection crank-piston mechanism according to claim 2,
wherein a hinge point of the swing arm and the crankshaft are located on a same side.

20. A dual-connection crank-piston mechanism, comprising a cylinder body, a piston and a crankshaft, wherein two connecting rods connected in series are hinged between the piston and the crankshaft, hinged ends of both an inner connecting rod and an outer connecting rod are slidably connected to a guide rail, and another end of the outer connecting rod is hinged to a crankshaft shank; and a stroke of the piston is greater than twice a length of the crankshaft shank, a difference between an upward movement speed and a downward movement speed of the piston is 1.4 to 3 times, and an outer end hinge point of the inner connecting rod always moves at one side of an axis of the piston.
